(19) United States
(12) Patent Application Publication
(10) Pub. No.: US 2004/0068759 A1
(43) Pub. Date: Apr. 8, 2004

(54) Apparatus and system for distribution of audio-visual signals over twisted pair cabling

(75) Inventors: Denis J. Sheehy, Shelton, CT (US); Jeffrey Todd, Danbury, CT (US); Larry Thomas, Newtown, CT (US)

Correspondence Address: Gordon & Jacobson, P.C., 65 Woods End Road, Stamford, CT, 06905, US

(73) Assignee: Arion Technologies, Inc.

(21) Appl. No.: 10/262,757

(22) Filed: Oct. 2, 2002

(51) Int. Cl. H04N 7/173; H04N 5/38; H04N 7/16; H04N 5/40

(52) U.S. Cl. 725/147; 725/146; 725/116; 725/117; 348/723; 348/724

(57) ABSTRACT

An audio/visual distribution system includes head end equipment for receiving a radio frequency audio-visual (A/V) signal from an information source, and a plurality of transmitters and receivers. The transmitters are coupled to the head end equipment and tune to any of a plurality of RF channels, convert the RF signal to a baseband A/V signal and transmit the baseband signal over twisted pair cabling for a distance of up to 2000 feet. The receivers receive the baseband signal and reconvert the baseband signal to an RF signal. The transmitters utilize differential drivers which receive voltages from a filtered split supply power source in order to drive the baseband signals over twisted pairs. The receivers include equalizers utilized in conjunction with the video signal, and differential amplifiers. The receivers generate NTSC baseband (stereo) audio and video signals and/or an RF signal.

### BACKGROUND OF THE INVENTION

1. Field of the Invention

This invention relates broadly to audio/video distribution systems. More particularly, this invention relates to apparatus and systems for distributing audio and video signals to multiple receivers over large distances using twisted pair (e.g., UTP Category 5 or 6) cabling instead of coaxial cable. The invention has particular applicability to office environments, training centers and schools, airports, conference facilities, hospitals and nursing homes, and financial service firms such as traders, investment bankers, and brokers, although it is not limited thereto.

2. State of the Art

The desirability of distributing audio and visual information in office, school, airport, hospital, and other environments is well known. Typically, in such environments, an RF signal, such as a cable or satellite television signal, or a data signal is received by a receiver on the premises, and is either split at the premises and forwarded to multiple recipient locations or retransmitted to the multiple recipient locations. In either case it is necessary to wire the premises with coaxial cable to each recipient screen. While such wiring is relatively simple in new construction, in existing buildings which are not already wired with coaxial cable, it is extremely difficult, time consuming, and expensive to wire with coaxial cable because of tight spaces and the relative inflexibility of the coaxial cable. On the other hand, most existing buildings are already wired with Category 5 or 6 data communications cabling, and even if not already pre-wired, can easily be wired with such cable.

### SUMMARY OF THE INVENTION

It is therefore an object of the invention to provide an audio/video distribution system which utilizes Category 5 or 6 wiring.

It is another object of the invention to provide an audio/video distribution system utilizing Category 5 or 6 wiring which can distribute signals up to two thousand feet.

It is a further object of the invention to provide an audio/video distribution system which distributes stereo audio information.

It is an additional object of the invention to provide an audio/video distribution system which allows a recipient to choose among information channels.

In accord with these objects, which will be discussed in detail below, an audio/visual distribution system includes head end equipment for receiving a radio frequency (RF) A/V signal from an information source, a plurality of transmitters coupled to the head end equipment, each transmitter adapted to tune to any of a plurality of RF channels, to convert the RF signal to a baseband A/V signal and to transmit the baseband signal over twisted pair cabling for a distance of up to 2000 feet, and a plurality of receivers which are adapted to receive the baseband signal and reconvert the baseband signal to an RF signal.

In accord with preferred aspects of the invention, the transmitters of the invention each utilize a plurality of differential drivers which receive voltages from a filtered split supply power source in order to drive the baseband signals over twisted pairs. With eight wires (four twisted pairs) in the Category 5 or 6 cable, one pair is used to transmit video from the transmitter to receiver, and two pairs are used to transmit audio in stereo from the transmitter to receiver. A fourth pair is used to receive channel control information from the receiver.

The plurality of receivers of the invention each include a plurality of differential amplifiers which receive voltages from a filtered split supply power source and which amplify the audio and video signals. Each receiver is also provided with an equalizer which is utilized in conjunction with the video signal. The receivers generate NTSC baseband (stereo) audio and video signals which, in one embodiment is fed directly to a monitor, and in another embodiment is provided to a modulator (which is included as part of the receiver) for generating an RF signal to a television.

With the provision the filtered split supply power sources, the equalizer, and the differential drivers and amplifiers, it is possible to drive the baseband signal over twisted pair cables for distances of up to 2000 feet while maintaining quality of signal.

Additional objects and advantages of the invention will become apparent to those skilled in the art upon reference to the detailed description taken in conjunction with the provided figures.

### BRIEF DESCRIPTION OF THE DRAWINGS

FIG. 1 is a representative block diagram showing the system of the invention.

FIG. 2 is a block diagram of the tuner of the A/V transmitter of the invention and its external connections.

FIG. 3 is a schematic diagram of the differential drivers and power supply of the A/V transmitter of the invention.

FIG. 4 is a schematic diagram of the A/V receiver of the invention.

FIG. 5 is a schematic diagram of a modulator which is included in the A/V receiver of one embodiment of the invention

### DETAILED DESCRIPTION OF THE PREFERRED EMBODIMENTS

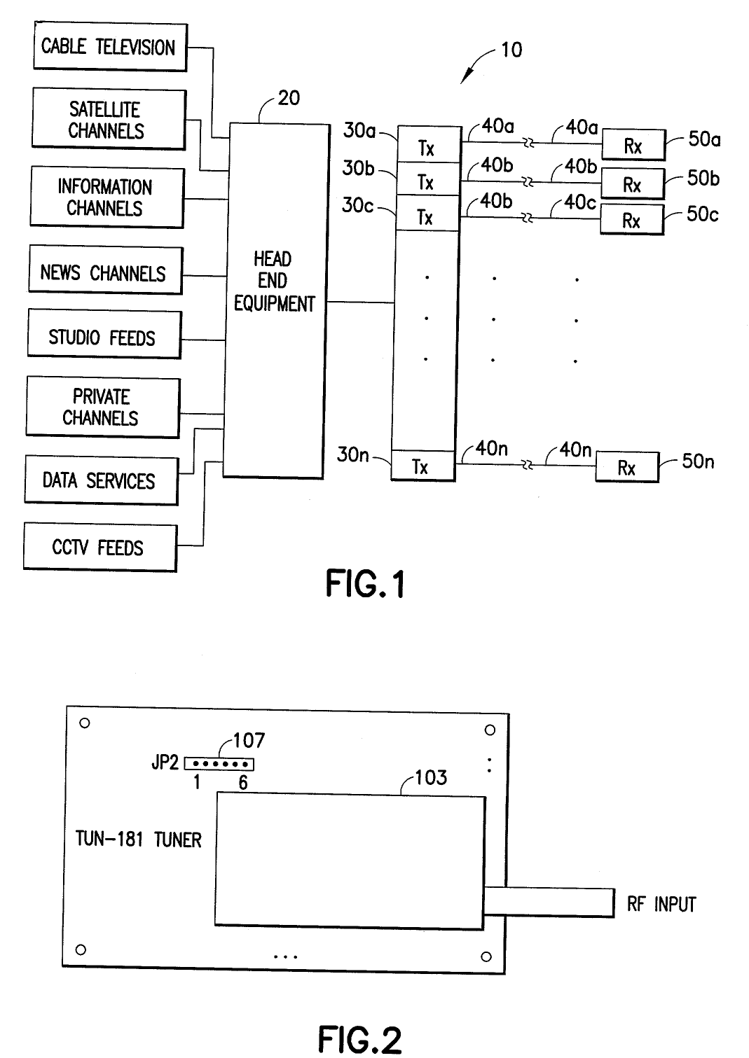

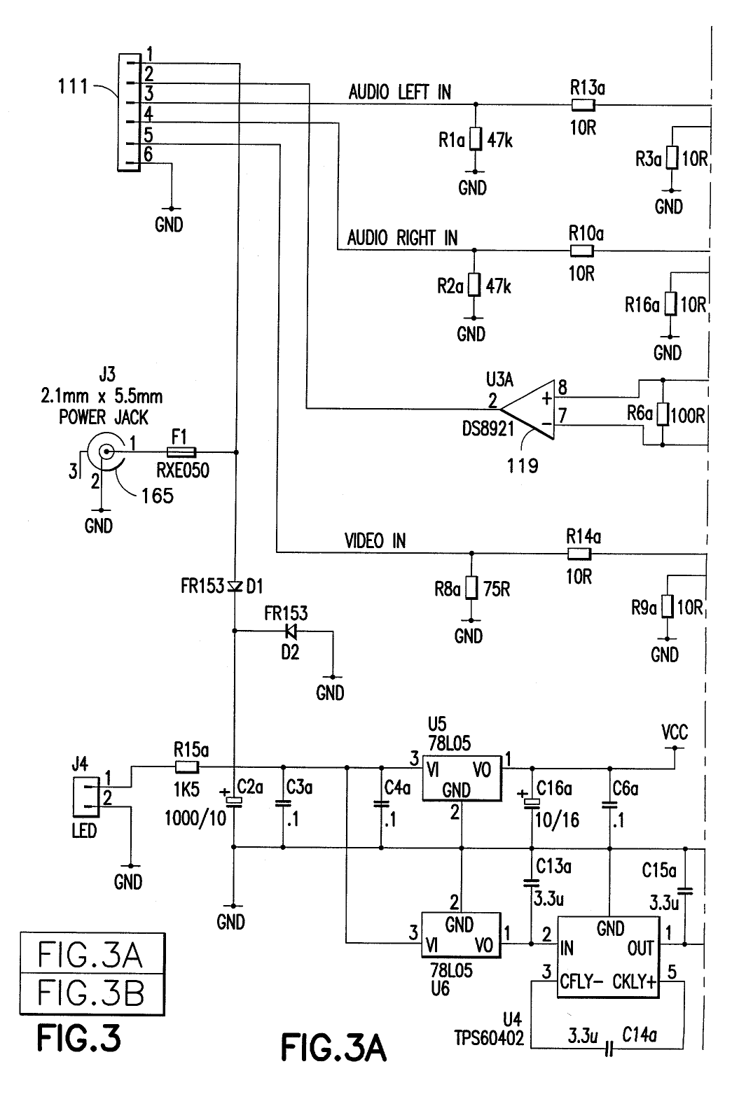

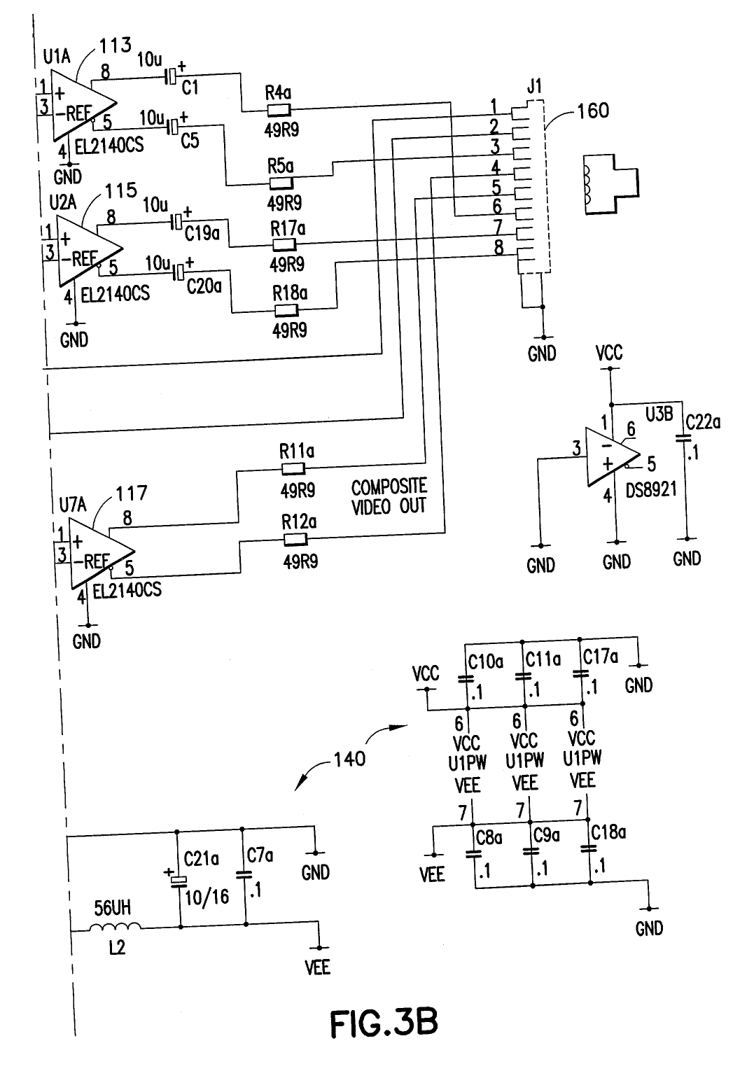

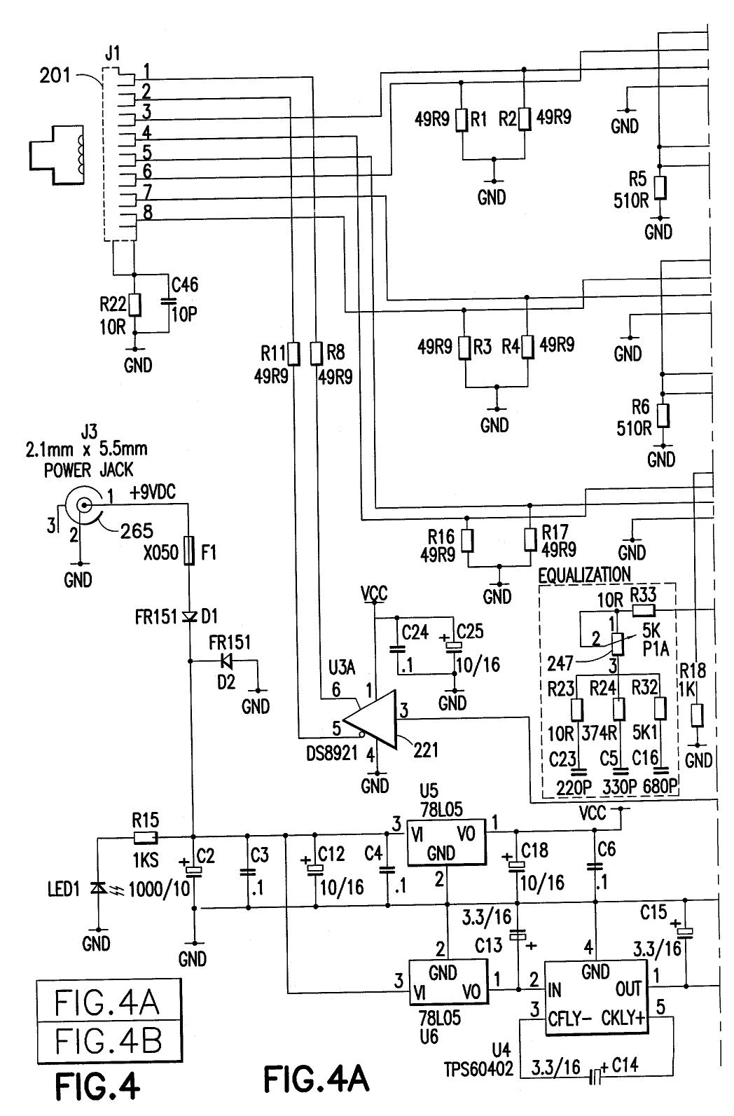

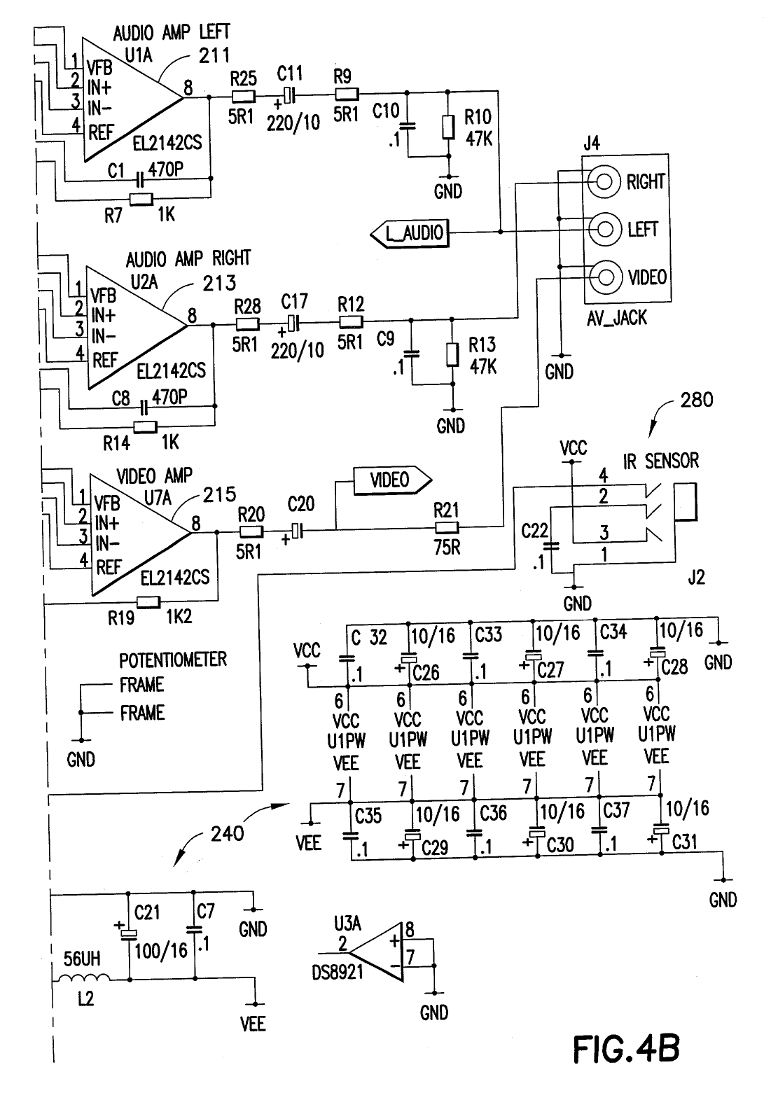

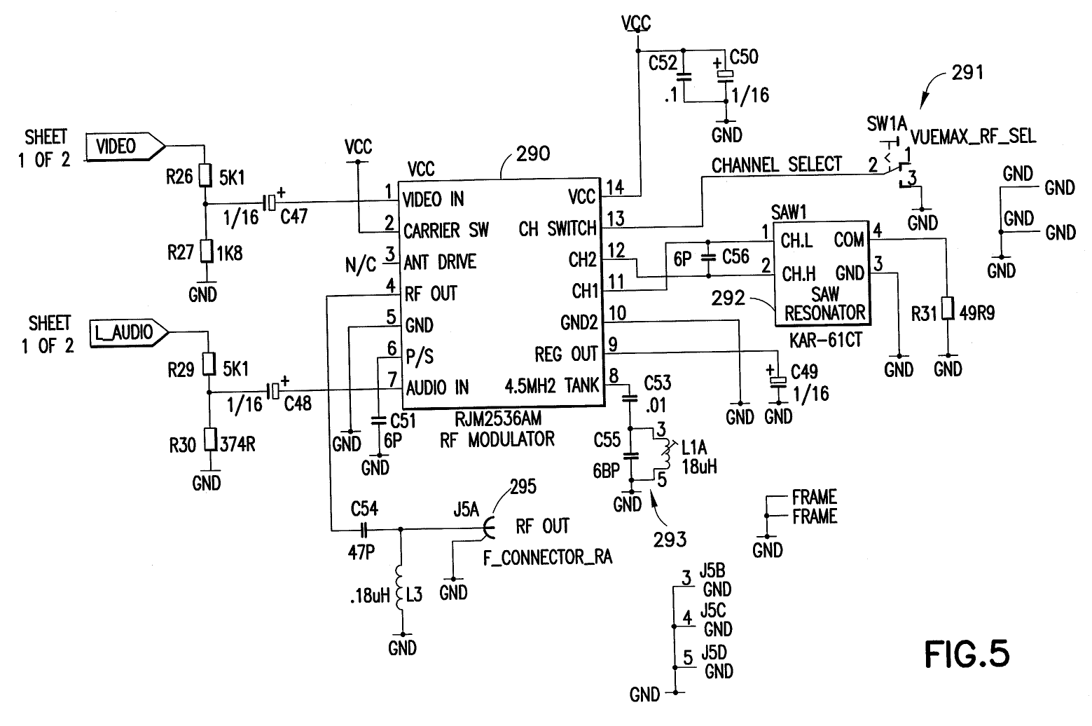

Turning now to FIG. 1, the system 10 of the invention is seen to include head end equipment 20, a plurality of transmitters 30a, 30b, 30c . . . 30n, coupled (e.g., via coax cables) to the head end equipment 20, twisted pair cables 40a, 40b, 40c, . . . 40n coupled to the transmitters and extending up to two thousand feet, and receivers 50a, 50b, 50c, . . . 50n coupled to the twisted pair cables. The head end equipment 20 receives an A/V signal from one or more of numerous information sources (e.g., cable television, satellite, news channels, data services, etc.) and provides multiple output cable signals on a single coaxial cable. The head end equipment may be any standard or custom equipment such as a Blonder Tongue, Old Bridge, N.J., models CDSR 6198, OC8D, RMDA860-30, BIDA49-860, and KU 0.92. The transmitters 30, as described in detail below with reference to FIGS. 2 and 3, are coupled via the coaxial cables to the head end equipment 20, and are adapted to tune to any of a plurality of RF channels, to convert the RF signal to a baseband A/V signal and to transmit the baseband signal over the twisted pair cables 40 for a distance of up to 2000 feet. The receivers 50, as described in detail below with reference to FIGS. 4 and 5 are coupled to the twisted pair cables (e.g., Category 5 or 6 cabling) and are adapted to receive the baseband signal, to generate NTSC video and audio (stereo) signals, and in a preferred embodiment to modulate the NTSC signals onto an RF signal.

Turning now to FIGS. 2 and 3, a block diagram of the tuner and a schematic diagram of the differential drivers and power supply of a representative A/V transmitter 30 of the invention is seen. In particular, a tuner 103, such as a Grandtec (Dallas, Tex.) TUN-181 tuner (modified to replace SAW filter with part number M1967, and to add a 10 pf capacitor to the tuner) is used for receiving an RF input cable signal and generating a baseband A/V signal which includes two audio (stereo) signals and a video signal. The baseband A/V signal is output at an output port 107, with the audio left signal on port 3 of the output port 107, audio right signal on port 4 of the output port 107, video signal on port 5 of the output port 107, ground signal on port 6 of the output port 107. Port 1 of the output port 107 is used to receive a 9V power supply from the power supply 140 (discussed below), while port 2 of the output port 107 is used as an infrared sensor input as discussed below. Port 107 is coupled via ribbon cable (not shown) to the circuitry shown in FIG. 3.

As seen in FIG. 3, the baseband A/V signals provided by the tuner 103 are received at port 111. The audio left, audio right and video signals are respectively provided to first inputs of differential drivers 113, 115, 117 (e.g., EL2140 chips of Elantec Inc., Malpitas, Calif.) via resistors R13a, R10a and R14a. Second inputs to differential drivers 113, 115, 117 are coupled to ground by respective resistors R3a, R16a, and R9a. Two additional pins (not shown) of the differential drivers are provided with voltages V_{CC} (+5V) and V_{EE} (−5V) which are generated by the filter split supply power source 140 which is discussed in more detail hereinafter. Two outputs from each of differential drivers 113, 115, 117 are fed respectively via capacitor C1a and resistor R4a, capacitor C5a and resistor R5a, capacitor C19a and resistor R17a, capacitor C20a and resistor R18a, and resistors R11a and R12a to an RJ45 jack 160.

As seen in FIG. 3, power source 140 is a split supply which receives a 9V direct current supply from jack 165 (which is also coupled to voltage signal pin 1 of port 111), and incorporates various electronic elements such as capacitors C2a, C3a, C4a, C16a, C6a, C13a, C15a, C21a, C14a, and C7a, inductor L2a and two three-terminal positive voltage regulators U5a and U6a, and an unregulated charge pump voltage inverter U4a. The V_{CC} (+5V) and V_{EE} (−5V) outputs of the split supply are filtered by decoupling capacitors C8a, C9a, C18a, C10a, C11a and C17a and, as discussed above, are supplied to respective pins of the differential drivers 113, 115, 117.

The transmitter circuit of FIG. 3 also includes an IR sensor portion, with signals received from the receiver (FIGS. 4 and 5) over a twisted pair via jack 160 supplied to a differential line receiver 119. The output of the receiver 119 is provided to port 2 of the “input port” 111. Port 2 of port 111 is in turn coupled to port 2 of the “output port” 107 of the tuner 103, and the tuner utilizes the IR sensor signal provided on this port to tune to a desired RF channel.

Turning now to FIGS. 4 and 5, schematic diagrams of the preferred A/V receiver of the invention are seen. The A/V receiver 50 receives at an RJ45 jack 201 signals from the A/V transmitter 30 via twisted pair cables 40. The signals at the jack 201 are filtered for ground noise by an RC circuit (R22 and C46). Two pins of the RJ45 jack 201 are terminated by resistors R1 and R2 and fed as first and second inputs (audio left) to differential amplifier 211. Two additional pins of the RJ45 jack are terminated by resistors R3 and R4 and fed as first and second inputs (audio right) to differential amplifier 213. Two more pins of the RJ45 jack are terminated by resistors R16 and R17 and fed as first and second inputs to differential amplifier 215. The last two pins of the RJ45 jack receive IR signal information from a differential line driver 221 as described below.

Each of the differential amplifiers 211, 213, and 215 (e.g., EL2142CS chips of Elantec Inc., Malpitas, Calif.) are provided with several additional inputs, such as one pin being coupled directly to ground, and a second pin being coupled to ground via a respective resistors R5, R6, and R18 which, together with resistors R7, R14 and R19, respectively set the gains of amplifiers 211, 213, and 215. In the case of amplifiers 211 and 213, bandwidth limiting capacitors C1 and C8 are coupled in parallel with the resistors R7 and R14 between the respective resistors R5, R6 and the respective outputs of the amplifiers. In addition, amplifiers 211, 213, and 215 are provided with voltages from the filtered split supply power source 240. The outputs of differential amplifiers 211 and 213 are respectively fed through resistors and capacitors R25 and C11l, and R28 and C17 to provide left and right NTSC baseband audio signals which may be fed to a modulator (as discussed hereinafter with reference to FIG. 5). In addition, or alternatively, the signals may be further processed via respective RC circuits (e.g., resistors R9, R10 and capacitor C10, and resistors R12, R13 and capacitor C9) and provided as audio signals to jack 272 for output to a NTSC monitor.

Returning to the video differential amplifier 215, the video signal is equalized by coupling one input and the output of the amplifier 215 to an equalizing circuit which includes resistors R23, R24, and R32, capacitors C23, C5 and C16, and potentiometer 247. The output of differential amplifier 215 is fed through resistor and capacitor R20 and C20 and provides the NTSC baseband video signal which may be fed to a modulator (as discussed hereinafter with reference to FIG. 5). In addition, or alternatively, the video signal may be fed via resistor R21 as the video signal to jack 272 for output to an LCD or plasma display or monitor (broadly called an “NTSC display”) such as a Century High Tech Corp., Taiwan, model CM20-068NP. Where an NTSC display is utilized, preferably, the receiver 50 and NTSC display are integrated into a single unit.

As seen in FIG. 4, power source 240 is a split supply which receives a 12V direct current power signal via jack 265, and incorporates various electronic elements such as capacitors C2, C3, C12, C4, C18, C6, C13, C15, C21, C14, and C7, inductor L2 and two three-terminal positive voltage regulators U5 and U6, and an unregulated charge pump voltage inverter U4. The V_{CC} and V_{EE} outputs of the split supply are filtered by decoupling capacitors C32, C33, C27, C34, C28, C35, C25, C36, C30, C37, and C31, as discussed above, are supplied to respective pins of the differential drivers 211, 213, 215.

The A/V receiver 50 also includes an IR sensor 280 and associated circuitry. In particular, the IR sensor has pins coupled to V_{CC} and ground and capacitor C22. The output of the IR sensor is provided as an input to the differential line driver 221 as discussed below. The differential line driver 221 also has pins coupled to V_{CC} and ground and differential outputs which are coupled to pins of the RJ45 jack 201 via resistors R11 and R8.

Turning now to FIG. 5, a schematic diagram of a modulator and associated circuitry which is included in the A/V receiver of one embodiment of the invention is seen. A preferred modulator is Japan Radio Corp. (San Jose, Calif.) RJM2536AM modulator. In the embodiment of FIG. 5, only the left audio and the video baseband signals are provided to the modulator 290 (i.e., the modulator 290 generates a mono-audio and video RF signals). The modulator 290 also receives inputs from a channel switch 291 (e.g., CH3/CH4), a resonator 292, a tank circuit 293, and voltages V_{CC} and ground. The output from the modulator is an RF A/V signal provided to a female F-connector jack 295 which may be coupled to a television. It will be appreciated by those skilled in the art that by using a different modulator and/or additional circuitry, and by providing both the left and right audio signals to the modulator, a stereo RF A/V signal can be generated.

There have been described and illustrated herein embodiments of audio/video distribution systems. While particular embodiments of the invention have been described, it is not intended that the invention be limited thereto, as it is intended that the invention be as broad in scope as the art will allow and that the specification be read likewise. Thus, while particular power supply circuits, power supply filters, equalizer circuits, and other circuits have been disclosed, it will be appreciated that other equivalent circuits could be used as well. In addition, while particular brands of differential amplifiers and drivers, modulators and tuners have been disclosed, it will be understood that others can be used. It will therefore be appreciated by those skilled in the art that yet other modifications could be made to the provided invention without deviating from its spirit and scope as claimed.

What is claimed is:

1. A system for distributing audio and video signals from head end equipment, comprising:
a) a plurality of transmitters coupled to the head end equipment, each transmitter including a tuner for receiving RF signals from the head end equipment and generating baseband audio and video signals therefrom, a plurality of differential drivers, and a first filtered split supply power source coupled to said plurality of differential drivers;
b) a plurality of cables, each having a plurality of twisted pair wires, individual pairs of said plurality of twisted pair wires coupled to respective of said differential drivers, said plurality of differential drivers of each of said plurality of transmitters driving at least a baseband video and a baseband audio signal over said individual pairs of said twisted pair wires for a distance of more than 1000 feet;
c) a plurality of receivers coupled to respective of said plurality of cables, each of said plurality of receivers including a plurality of differential amplifiers, at least a first of said plurality of differential amplifiers for said baseband audio signal and a second of said plurality of differential amplifiers for said baseband video signal, a second filtered split supply power source coupled to said plurality of differential amplifiers, and an equalizing means coupled to said differential amplifier for said video signal, said plurality of differential amplifiers for each of said plurality of receivers receiving said baseband video and baseband audio signals and generating therefrom NTSC baseband audio and NTSC baseband video signals.

2. A system according to claim 1, wherein:
each of said plurality of receivers includes a radio frequency (RF) modulator coupled to said plurality of differential amplifiers, said RF modulator for generating an RF audio-visual output signal suitable for viewing on a television.

3. A system according to claim 2, wherein:
each of said plurality of transmitters includes two differential drivers for driving left audio and right audio signals, and
each of said plurality of receivers includes two differential amplifiers for generating NTSC baseband left audio and NTSC baseband right audio signals.

4. A system according to claim 3, wherein:
said plurality of cables constitute Category 5 or Category 6 cables having at least four twisted pairs.

5. A system according to claim 4, wherein:
each of said plurality of receivers includes an infrared (IR) detector and a first driver which drives an IR control signal over a respective one of said plurality of twisted pairs, and
each of said plurality of transmitters includes a second driver coupled to said plurality of twisted pairs carrying said IR control signal, said second driver providing said IR control signal to a respective said tuner, said tuner responsive to said IR control signal.

6. A system according to claim 1, wherein:
each of said plurality of transmitters includes two differential drivers for driving left audio and right audio signals, and
each of said plurality of receivers includes two differential amplifiers for generating NTSC baseband left audio and NTSC baseband right audio signals.

7. A system according to claim 6, further comprising:
a plurality of audio-visual NTSC displays coupled to respective of said plurality of receivers, each audio-visual NTSC display receiving a respective said NTSC baseband left audio and a respective said NTSC baseband right audio signal and a respective said NTSC video signal and generating respective stereo sound and visual displays therefrom.

8. A system according to claim 7, wherein:
each of said plurality of audio-visual NTSC displays is integrated with a respective one of said plurality of said receivers.

9. A system according to claim 6, wherein:
said plurality of cables constitute Category 5 or Category 6 cables having at least four twisted pairs.

10. A system according to claim 6, wherein:
each of said plurality of receivers includes an infrared (IR) detector and a first driver which drives an IR control signal over a respective one of said plurality of twisted pairs, and
each of said plurality of transmitters includes a second driver coupled to said plurality of twisted pairs carrying said IR control signal, said second driver providing said IR control signal to a respective said tuner, said tuner responsive to said IR control signal.

11. A system for distributing audio and video signals, comprising:
a) head end equipment which receives audio and video signals from an outside source;
b) a plurality of transmitters coupled to said head end equipment, each transmitter including a tuner for receiving RF signals from the head end equipment and generating baseband audio and video signals therefrom, a plurality of differential drivers, and a first filtered split supply power source coupled to said plurality of differential drivers;
c) a plurality of cables, each having a plurality of twisted pair wires, individual pairs of said plurality of twisted pair wires coupled to respective of said differential drivers, said plurality of differential drivers of each of said plurality of transmitters driving at least a baseband video and a baseband audio signal over said individual pairs of said twisted pair wires for a distance of more than 1000 feet;
d) a plurality of receivers coupled to respective of said plurality of cables, each of said plurality of receivers including a plurality of differential amplifiers, at least a first of said plurality of differential amplifiers for said baseband audio signal and a second of said plurality of differential amplifiers for said baseband video signal, a second filtered split supply power source coupled to said plurality of differential amplifiers, and an equalizing means coupled to said differential amplifier for said video signal, said plurality of differential amplifiers for each of said plurality of receivers receiving said baseband video and baseband audio signals and generating therefrom NTSC baseband audio and NTSC baseband video signals.

12. A system according to claim 11, wherein:
each of said plurality of receivers includes an radio frequency (RF) modulator coupled to said plurality of differential amplifiers, said RF modulator for generating an RF audio-visual output signal suitable for viewing on a television.

13. A system according to claim 12, wherein:
each of said plurality of transmitters includes two differential drivers for driving left audio and right audio signals, and
each of said plurality of receivers includes two differential amplifiers for generating NTSC baseband left audio and NTSC baseband right audio signals.

14. A system according to claim 13, wherein:
said plurality of cables constitute Category 5 or Category 6 cables having at least four twisted pairs.

15. A system according to claim 14, wherein:
each of said plurality of receivers includes an infrared (IR) detector and a first driver which drives an IR control signal over a respective one of said plurality of twisted pairs, and
each of said plurality of transmitters includes a second driver coupled to said plurality of twisted pairs carrying said IR control signal, said second driver providing said IR control signal to a respective said tuner, said tuner responsive to said IR control signal.

16. A system according to claim 11, wherein:
each of said plurality of transmitters includes two differential drivers for driving left audio and right audio signals, and
each of said plurality of receivers includes two differential amplifiers for generating NTSC baseband left audio and NTSC baseband right audio signals.

17. A system according to claim 16, further comprising:
a plurality of audio-visual NTSC displays coupled to respective of said plurality of receivers, each audio-visual NTSC display receiving a respective said NTSC baseband left audio and a respective said NTSC baseband right audio signal and a respective said NTSC video signal and generating respective stereo sound and visual displays therefrom.

18. A system according to claim 17, wherein:
each of said plurality of audio-visual NTSC displays is integrated with a respective one of said plurality of said receivers.

19. A system according to claim 16, wherein:
said plurality of cables constitute Category 5 or Category 6 cables having at least four twisted pairs.

20. A system according to claim 16, wherein:
each of said plurality of receivers includes an infrared (IR) detector and a first driver which drives an IR control signal over a respective one of said plurality of twisted pairs, and
each of said plurality of transmitters includes a second driver coupled to said plurality of twisted pairs carrying said IR control signal, said second driver providing said IR control signal to a respective said tuner, said tuner responsive to said IR control signal.
